(19) United States
(12) Patent Application Publication
(10) Pub. No.: US 2009/0080119 A1
(43) Pub. Date: Mar. 26, 2009

(54) HEAD SLIDER, AND METHOD FOR MANUFACTURING HEAD SLIDER

(75) Inventors: Kazuaki KURIHARA, Kawasaki (JP); Tsuyoshi AOKI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/211,452

(22) Filed: Sep. 16, 2008

(30) Foreign Application Priority Data
Sep. 20, 2007 (JP) 2007-244376
Jan. 24, 2008 (JP) 2008-013767

(51) Int. Cl. G11B 5/33

(52) U.S. Cl. 360/313; G9B/5.104

(57) ABSTRACT

According to an aspect of an embodiment, a head slider includes: a slider substrate; and an operating unit arranged on the slider substrate, the operating unit having a pair of electrodes and a piezoelectric component arranged between the pair of electrodes, the pair of electrodes being constituted by a first electrode and a second electrode, in which the product of the Young's modulus and the thickness of the first electrode in the direction from the first electrode to the second electrode is larger than the product of the Young's modulus and the thickness of the second electrode in the direction from the first electrode to the second electrode. The head slider further includes a magnetic head arranged on the slider substrate with the operating unit, opposite to the slider substrate.

### CROSS REFERENCE TO RELATED APPLICATIONS

This application is based upon and claims the benefit of priority from the prior Japanese Patent Applications No. 2007-244376 filed on Sep. 20, 2007, and No. 2008-13767 filed on Jan. 24, 2008, the entire contents of which are incorporated herein by reference.

### BACKGROUND

1. Field

This art relates to a head slider, a method for manufacturing a head slider, and a storage device including a head slider.

2. Description of the Related Art

In recent years, in storage devices (storage-medium-driving devices) such as hard disk drives (HDDs), with an increase in recording density, distances between head sliders and storage media, i.e., flying heights, have been very small. Furthermore, numbers of revolutions of storage media have tended to increase so as to increase in the read and write speeds of storage devices.

Various attempts have been made to control flying heights. For example, Japanese Laid-open Patent Publication No. 2005-11413 discloses a method for mounting a heating element, i.e., a thermal actuator, on a head slider as a method for controlling the flying height. In Japanese Laid-open Patent Publication No. 2005-11413, a heating wire serving as a thermal actuator is energized to be thermally expanded. The thermal expansion results in the deformation of the surface of the head slider facing a magnetic disk to control the flying height of the magnetic head. However, this control method disadvantageously has a limited response speed because thermal expansion is utilized, so that the flying height is not adequately controlled in response to a change in flying height.

As another method for controlling the flying height, for example, Japanese Laid-open Patent Publication No. 2000-348321 discloses a method for using a piezoelectric microactuator (piezoelectric element). Japanese Laid-open Patent Publication No. 2000-348321 discloses a technique for controlling the flying height by arranging the piezoelectric microactuator between a substrate and a magnetic head. Specifically, energization results in the deformation of the piezoelectric microactuator, thereby controlling the flying height of the magnetic head. A rapid control of the flying height with the piezoelectric actuator is achieved compared with the case of using the thermal actuator.

However, the head slider disclosed in Japanese Laid-open Patent Publication No. 2000-348321 is produced by bonding a piezoelectric actuator to each individual slider substrate or a columnar slider substrate with an adhesive. Thus, the positioning of these components is difficult during bonding, thus limiting miniaturization. The difficulty in positioning disadvantageously affects the yield during assembling. Thus, the cost cannot be reduced.

### SUMMARY

According to an aspect of an embodiment, a head slider includes: a slider substrate; an operating unit arranged on the slider substrate, the operating unit having a pair of electrodes and a piezoelectric component arranged between the pair of electrodes, the pair of electrodes being constituted by a first electrode and a second electrode, in which the product of the Young's modulus and the thickness of the first electrode in the direction from the first electrode to the second electrode is larger than the product of the Young's modulus and the thickness of the second electrode in the direction from the first electrode to the second electrode; and a magnetic head arranged on the slider substrate with the operating unit, opposite to the slider substrate.

### BRIEF DESCRIPTION OF THE DRAWINGS

FIG. 1 is a schematic view of a magnetic recording device including a head slider of an embodiment;

FIG. 2 is a schematic view of a magnetic recording device including a head slider of an embodiment;

FIG. 3 is a schematic perspective view of a head slider according to an embodiment;

FIG. 4 is a schematic cross-sectional view of a magnetic-head support including a head slider and a suspension according to an embodiment;

FIG. 5 is an enlarged schematic cross-sectional view of portion A of the head slider shown in FIG. 4;

FIGS. 6A to 6D are conceptual diagrams illustrating the operation of a unimorph piezoelectric element;

FIG. 7 is a schematic view of a head slider when an actuator provided with a unimorph piezoelectric element is simulated;

FIG. 8 is a schematic view of a head slider when an actuator provided with a unimorph piezoelectric element is simulated;

FIG. 9 is a conceptual perspective view of an actuator of the head slider shown in FIGS. 3 and 4;

FIG. 10 is a schematic view illustrating the positional relation of an element and an operating unit when viewed from the leading edge of a head slider; and

FIGS. 11A to 11H are schematic cross-sectional views illustrating steps in a method for manufacturing a head slider according to an embodiment.

### DESCRIPTION OF THE PREFERRED EMBODIMENTS

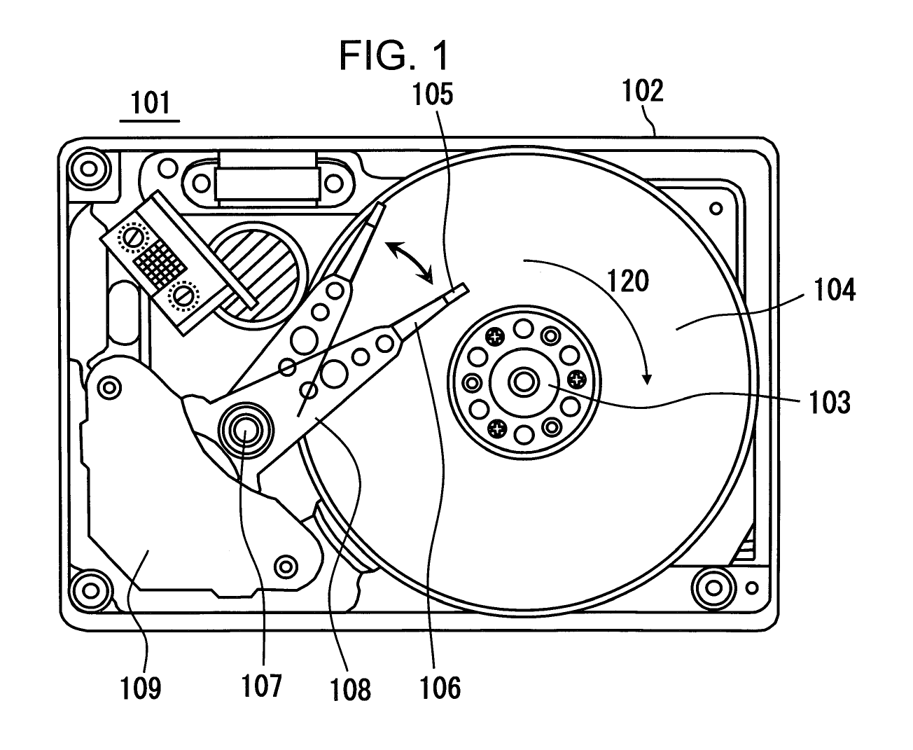

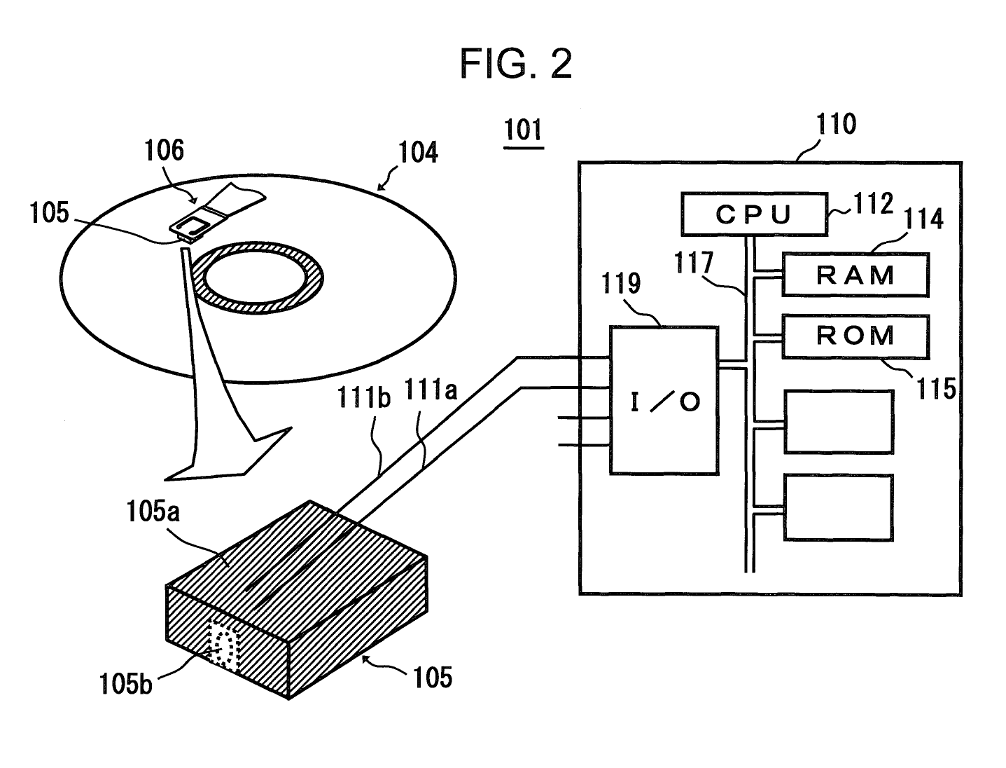

A magnetic disk drive including a head slider of an embodiment will be briefly described below with reference to FIGS. 1 and 2. FIG. 1 is a schematic view illustrating a magnetic recording device (hard disk drive (HDD)) including a head slider of an embodiment.

A magnetic disk drive 101 shown in FIG. 1 includes a housing 102. The magnetic disk drive 101 also includes a magnetic disk 104 attached to a spindle 103 and spinning in the direction of an arrow 120, a head slider 105 on which a magnetic head for writing and reading information on and from the magnetic disk 104 is mounted, a suspension 106 supporting the head slider 105, a carriage arm 108 to which the suspension 106 is fixed, the carriage arm 108 pivoting on an arm support 107 and moving along a surface of the magnetic disk 104, and an electromagnetic actuator 109 driving the carriage arm 108 in the housing 102. The housing 102 is provided with a cover (not shown). These components described above are arranged in an interior space defined by the housing 102 and the cover.

As shown in FIG. 2, the magnetic disk drive 101 includes a controller 110 configured to control the operation of the magnetic disk drive 101. The controller 110 is mounted on, for example, a control board (not shown) arranged in the housing 102. As shown in FIG. 2, the controller 110 includes a central processing unit (CPU) 112, a random access memory (RAM) 114 that temporarily stores data and the like processed by the CPU 112, a read only memory (ROM) 115 that stores a control program and the like, an input/output circuit 119 that sends signals to the outside and receives signals from the outside, and a bus 117 that transmits signals among these circuits.

As shown in FIG. 2, the head slider 105 includes a magnetic head 105b formed in a slider substrate 105a. The magnetic head 105b is connected to the input/output circuit 119 in the controller 110 through leads 111a and 111b. The magnetic head 105b writes information on the magnetic disk 104 (write operation) and reads information stored in the magnetic disk 104 (read operation). When the read operation or write operation is performed, the electromagnetic actuator 109 drives the carriage arm 108 to transfer the magnetic head 105b to a target track on the magnetic disk 104.

### Head Slider

Embodiments of a head slider of the present invention will be described below.

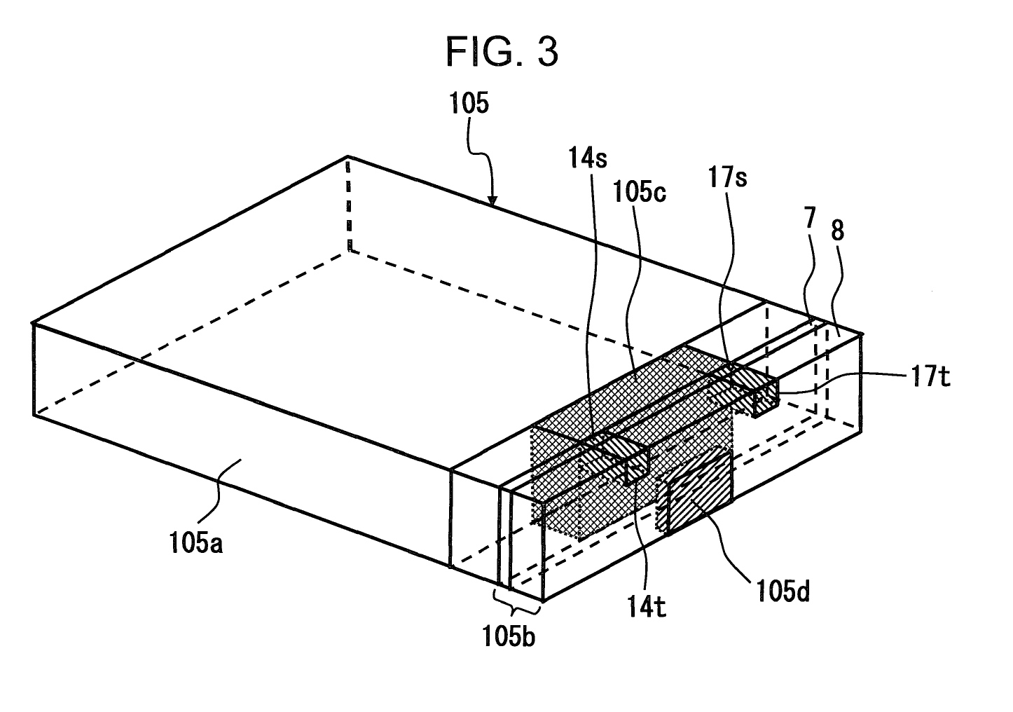

FIG. 3 is a schematic perspective view of a structure of a head slider according to an embodiment. As shown in FIG. 3, the head slider 105 includes the slider substrate (hereinafter, also referred to simply as a “substrate”) 105a, an actuator 105c, and the magnetic head 105b. The actuator 105c is arranged at an end of the slider substrate 105a. The actuator 105c is located between the slider substrate 105a and an insulating layer 7 and the magnetic head 105b. The magnetic head 105b includes an element 105d and an insulating layer 8. That is, the element 105d is remote from the slider substrate 105a with the actuator 105c provided therebetween. The insulating layer 7 includes vias 14s and 17s electrically connected to electrode pads 14 and 17, respectively, arranged on the actuator 105c. The insulating layer 8 of the magnetic head 105b includes external terminals 14t and 17t arranged on a surface of the magnetic head 105b, the external terminals 14t and 17t being electrically connected to the vias 14s and 17s, respectively.

The slider substrate 105a is composed of a ceramic material such as AlTiC (Al₂O₃—TiC). AlTiC, which is a kind of ceramic, is a fired product of alumina (Al₂O₃) and titanium carbide (TiC).

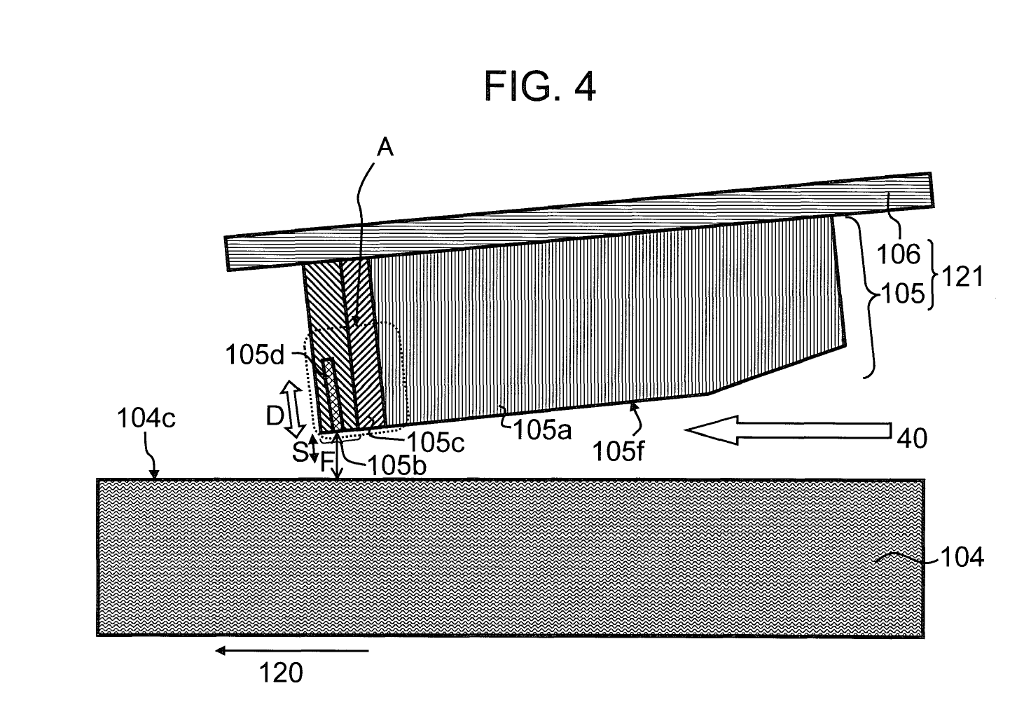

FIG. 4 is a schematic cross-sectional view of a magnetic-head support according to an embodiment, the magnetic-head support including the suspension and the magnetic head slider of the present invention. The magnetic-head support is also referred to as a “head gimbal assembly (HGA)”.

As shown in FIG. 4, a magnetic-head support 121 is usually defined as a structure constituted by the suspension 106 provided with the head slider 105, a base plate (not shown), and the like. Alternatively, the suspension 106 without the head slider 105, i.e., the suspension 106 alone is referred to as the magnetic-head support, in some cases. Furthermore, a structure constituted by the suspension 106 provided with either the head slider 105 or the base plate (not shown) is referred to as the magnetic-head support 121, in some cases. The suspension 106 is formed of, for example, a stainless-steel plate having a thickness of 20 μm. The base plate (not shown) serves to connect the suspension 106 to an end of the carriage arm 108 as shown in FIG. 1. The head slider 105 is attached to the end of the suspension remote from the carriage arm 108. The head slider 105 is located so as to face a surface 104c of the magnetic disk.

As shown in FIG. 4, an airflow 40 is generated below a floating surface 105f of the head slider 105 by the rotation of the magnetic disk in the direction of the arrow 120. The airflow 40 enables the head slider 105 to create a lifting force, thereby lifting the head slider 105 from the surface 104c of the magnetic disk 104. Driving the actuator 105c shifts the magnetic head 105b toward a magnetic recording medium (in the direction of arrow D).

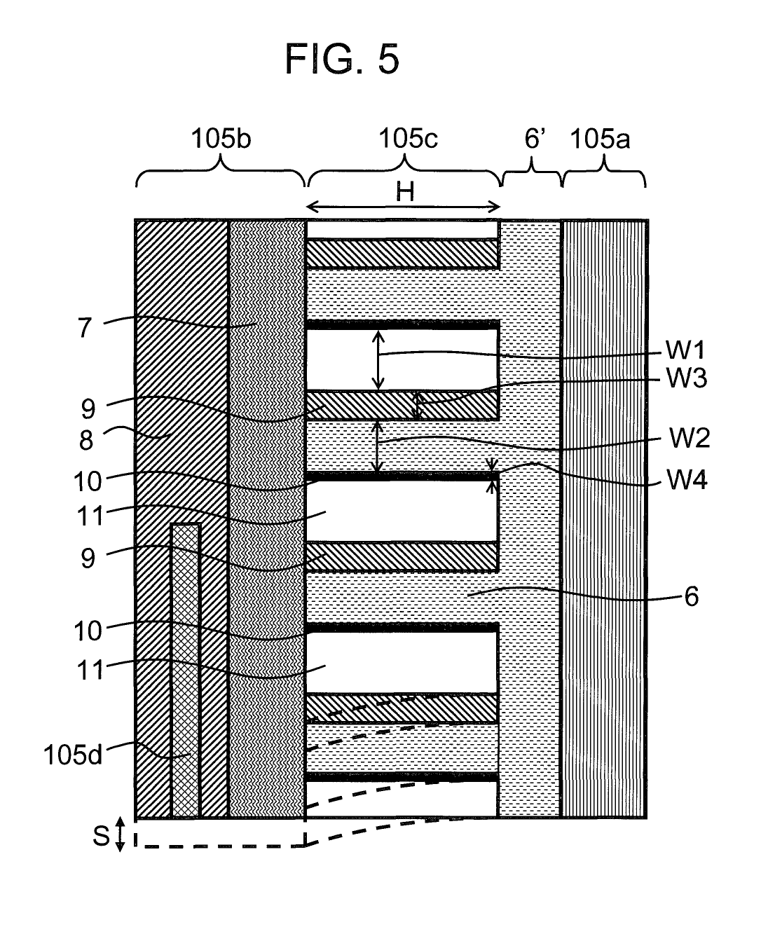

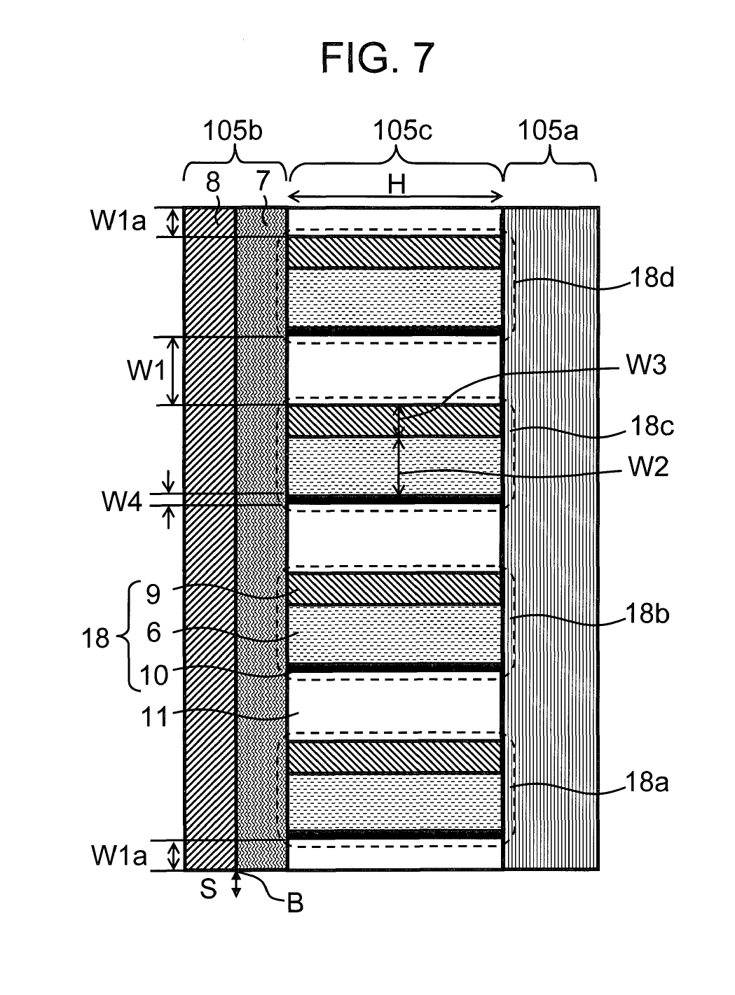

FIG. 5 is an enlarged schematic cross-sectional view of portion A of the head slider shown in FIG. 4. The actuator 105c is driven in the storage device and serves to control the distance between the magnetic disk 104 and the magnetic head 105b. The actuator 105c includes piezoelectric components 6a, 6b, 6c, and 6d (hereinafter, also referred to collectively as a “piezoelectric component 6”), first electrodes 9a, 9b, 9c, and 9d (hereinafter, also referred to collectively as a “first electrode 9”), second electrodes 10a, 10b, 10c, and 10d (hereinafter, also referred to collectively as a “second electrode 10”), and resin components 11a, 11b, 11c, 11d, and 11e (hereinafter, also referred to collectively as a “resin component 11”). The piezoelectric component 6 is arranged between a pair of elastic electrodes consisting of the first electrode 9 and the second electrode 10. Portions 18a, 18b, 18c, and 18d including the pair of electrodes 9 and 10 and the piezoelectric component 6 correspond to the operating unit of the head slider of the present invention (see FIG. 7). Hereinafter, these portions 18a, 18b, 18c, and 18d are also referred to collectively as the “operating unit 18”.

While a plurality of operating units are arrayed in this embodiment, the head slider of the present invention may have at least one operating unit. From the viewpoint of achieving a large force acting on the magnetic head 105b and a contribution to the high-speed control of the flying height, a head slider preferably includes the actuator 105c having a plurality of the operating units.

The first electrode 9 exhibits a high resistance to deformation due to an external force compared with the second electrode 10. In other words, the first electrode 9 exhibits a high resistance to crushing compared with the second electrode 10. The resistance to deformation can be quantitatively expressed as the product of the Young's modulus of the electrode (modulus of elasticity in tension) and the thickness. For example, in the case where the first electrode 9 and the second electrode 10 are composed of the same material, as shown in FIG. 5, the first electrode 9 is thicker than the second electrode 10; hence, the first electrode 9 exhibits a high resistance to deformation compared with the second electrode 10. Alternatively, for example, in the case where the first electrode 9 has a thickness equal to that of the second electrode 10, a head slider including the first electrode 9 having a Young's modulus higher than that of the second electrode 10 is exemplified as another embodiment. Also in this embodiment, the first electrode 9 exhibits a high resistance to deformation compared with the second electrode 10.

Examples of a material that can be used for the first electrode 9 and the second electrode 10 include conductive materials, such as metals, e.g., nickel (Ni), platinum (Pt), iridium (Ir), chromium (Cr), and copper (Cu); nitrides, e.g., titanium nitride (TiN); carbides, e.g., tungsten carbide (WC); and oxides, e.g., indium-tin oxide (ITO).

The electrodes may have a laminated structure having two or more layers. In this case, a layer in contact with the piezoelectric component 6 is composed of the conductive material described above. The material constituting another layer is not particularly limited and may be an insulating material. The resistance to the deformation of the electrode having the laminated structure with two or more layers is quantitatively expressed as the product of the Young's modulus and the thickness of each layer constituting the laminated structure.

The piezoelectric component 6 is composed of a piezoelectric material. Examples of the piezoelectric material that can be used for the piezoelectric component 6 include perovskite oxides, such as lead zirconate titanate (Pb(Zr,Ti)O₃ (PZT)), lead lanthanum zirconate titanate ((Pb,La) (Zr,Ti)O₃ (PLZT)), Nb-containing PZT, PNN-PZT {Pb(Ni,Nb)O₃—PbTiO₃—PbZrO₃}, and PMN-PZT {Pb(Mg,Nb)O₃—PbTiO₃—PbZrO₃}. Furthermore, potassium niobate (KNbO₃), aluminum nitride (AlN), and the like may be used.

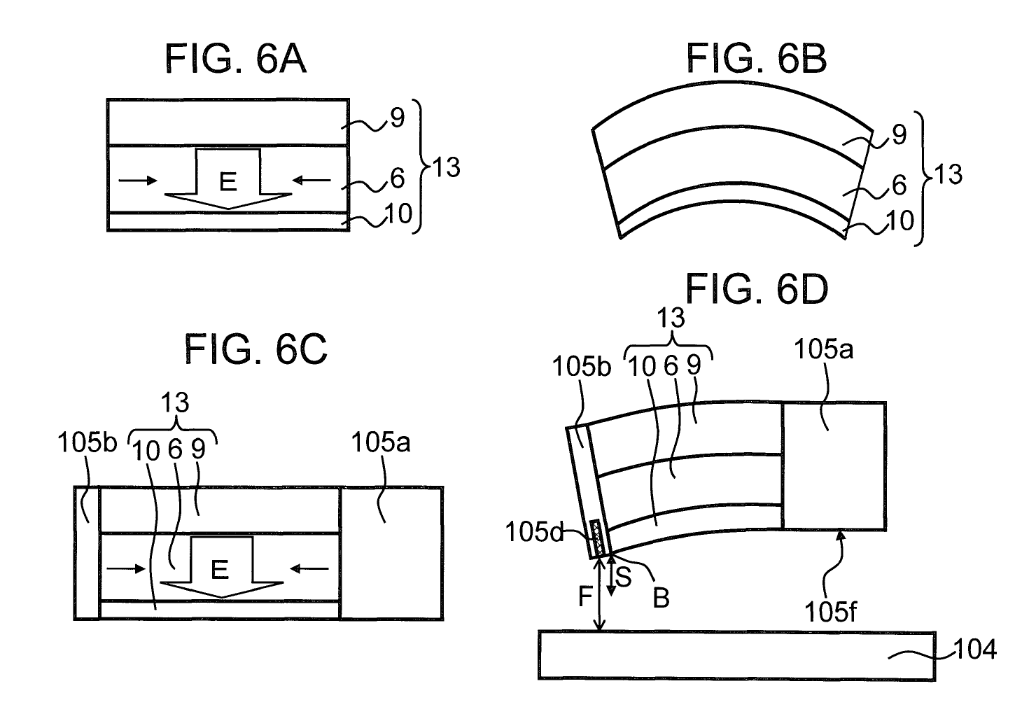

The portion constituted by the piezoelectric component 6, the first electrode 9, and the second electrode 10 is referred to as a unimorph piezoelectric element. FIGS. 6A to 6D are conceptual diagrams illustrating the operation of a unimorph piezoelectric element.

A unimorph piezoelectric element 13 is an actuator having a structure such that bending displacement is produced by utilizing the displacement of the piezoelectric component 6 in the d31 direction (transversal piezoelectric effect or d31 effect). As shown in FIG. 6A, the application of an electric field E generated by the first electrode 9 and the second electrode 10 to the piezoelectric component 6 produces a compressive force acting on the piezoelectric component 6 in the direction perpendicular to the direction of the electric field E. The first and second electrodes 9 and 10 restrict the deformation of the piezoelectric component. The first electrode 9 has a rigidity higher than that of the second electrode 10; hence, the deformation of the first electrode 9 is smaller than that of the second electrode 10. Therefore, as shown in FIG. 6B, the unimorph piezoelectric element 13 is deformed to have a convex shape when the first electrode 9 faces upward.

FIG. 6C is a conceptual diagram illustrating a unimorph piezoelectric element arranged between a substrate and a magnetic head. The substrate 105a is arranged on one end of the unimorph piezoelectric element (operating unit) 13. The magnetic head 105b is arranged on the other end. The substrate 105a is composed of a hard AlTiC as described above and has a thickness of about 1 mm. The magnetic head 105b is composed of various metal oxides and metals and mainly contains a material softer than AlTiC. The magnetic head 105b usually has a thickness of about several tens of micrometers, which is very small compared with the substrate 105a. As shown in FIG. 6D, in the case where the piezoelectric element 13 is deformed, the substrate 105a side of the piezoelectric element 13 is negligibly deformed because the substrate 105a side is fixed to the slider substrate 105a. In contrast, the magnetic head 105b side of the unimorph piezoelectric element 13 is largely displaced in the direction parallel to the direction of the electric field E. As a result, the magnetic head 105b is also largely displaced in the direction parallel to the direction of the electric field E. In other words, the magnetic head 105b is largely displaced in the direction in which a write/read element and the magnetic disk medium are connected to each other (spacing direction: direction of arrow S shown in FIG. 6D) in the storage device. Thus, the distance between the element 105d of the magnetic head 105b and the magnetic disk 104, i.e., the flying height F of the head slider, is controlled by controlling the displacement of point B of the unimorph piezoelectric element 13 located on the floating surface 105f and adjacent to the magnetic head 105b.

For example, in a known piezoelectric element (piezoelectric actuator) utilizing displacement in the d15 direction, the polarization direction of the piezoelectric component differs from the direction in which a driving voltage is applied. Thus, in a production process, the piezoelectric component is polarized. The polarized piezoelectric component is sliced to reduce the size. Then the resulting small piezoelectric component must be bonded to a slider substrate with an adhesive. It is not preferred to bond the processed piezoelectric component having a size of, for example, about 20 μm to the slider substrate from the viewpoint of achieving cost reduction and an increase in yield. To bond the piezoelectric component to the slider substrate with the adhesive, the piezoelectric component needs to have a thickness of at least about 100 μm. Even in this case, a significant increase in production cost is unavoidable because of assembly including the bonding of a minute component with high precision.

In contrast, in a piezoelectric actuator including a unimorph piezoelectric element, the whole of a production process of the actuator can be performed on a substrate wafer; hence, the actuator and the magnetic head can be successively formed. The production process of the actuator will be described in detail in “Method for Manufacturing Head Slider” described below. In this process, a small actuator can be formed compared with the known process in which the actuator is bonded to the slider with the adhesive. For example, the actuator shown in FIG. 5 has a thickness H of several micrometers to several tens of micrometers.

In the case where the resonance frequency of the magnetic head and the actuator is near the operating frequency used for driving the actuator, the resonance of a portion moved by the actuator may inhibit the normal operation of the actuator. To eliminate the resonance of the portion, it is necessary to operate the actuator at a frequency lower than the resonance frequency of the portion moved by the actuator. The head slider according to this embodiment includes the actuator arranged between the slider substrate and the magnetic head, so that the portion moved by the actuator has a small size and thus has a high resonance frequency. Therefore, the operating frequency of the actuator (i.e., piezoelectric element) can be set at a high frequency. A high operating frequency of the piezoelectric element results in the rapid control of the flying height of the magnetic head with high precision. Specifically, the flying height can be corrected in response to a change in the distance between the floating surface (reference numeral 105f shown in FIG. 4) of the slider and the storage medium (reference numeral 104 shown in FIG. 4) due to various factors, such as a change in atmospheric pressure, thermal expansion, the impact of a head crash, and vibration due to a motor of the storage device. Furthermore, the flying height can be stabilized by rapid correction of the flying height in response to a change in flying height during one revolution of the disk due to, for example, undulations and irregularities of the magnetic disk and the side-to-side runout of the spindle.

Moreover, the use of the actuator including the unimorph piezoelectric element results in a displacement sufficient to control the flying height. For example, in a slider including the magnetic head 105b, the actuator 105c, and the AlTiC substrate 105a as shown in FIG. 7, the displacement of point B in the spacing direction (direction of arrow S) when a voltage of 30 V was applied across the electrodes to generate an electric field was determined by a simulation. The actuator 105c was set to include four operating units longitudinally arranged with a resin component provided between adjacent operating units, each of the operating units having a piezoelectric component, composed of PZT, with a width (W2 shown in FIG. 7) of 15 μm, the first electrode, composed of Ni, with a width (W3 shown in FIG. 7) of 5 μm, and the second electrode with a width (W4 shown in FIG. 7) of 0.1 μm, each operating unit having a thickness (H shown in FIG. 7) of 20 μm, and each of the resin components having a width (W1 shown in FIG. 7) of 5 μm. The thickness W1a of each of the resin component located below the operating unit 18a and the resin component located on the top of the operating unit 18d was set at 5 μm. The simulation of motion of slider was performed under conditions in which a voltage of 30 V was applied across the electrodes to generate an electric field. The results demonstrated that the displacement of point B was 14.9 nm in the spacing direction (direction of arrow S). The flying height is currently about 10 nm; hence, the displacement is sufficient to control the flying height.

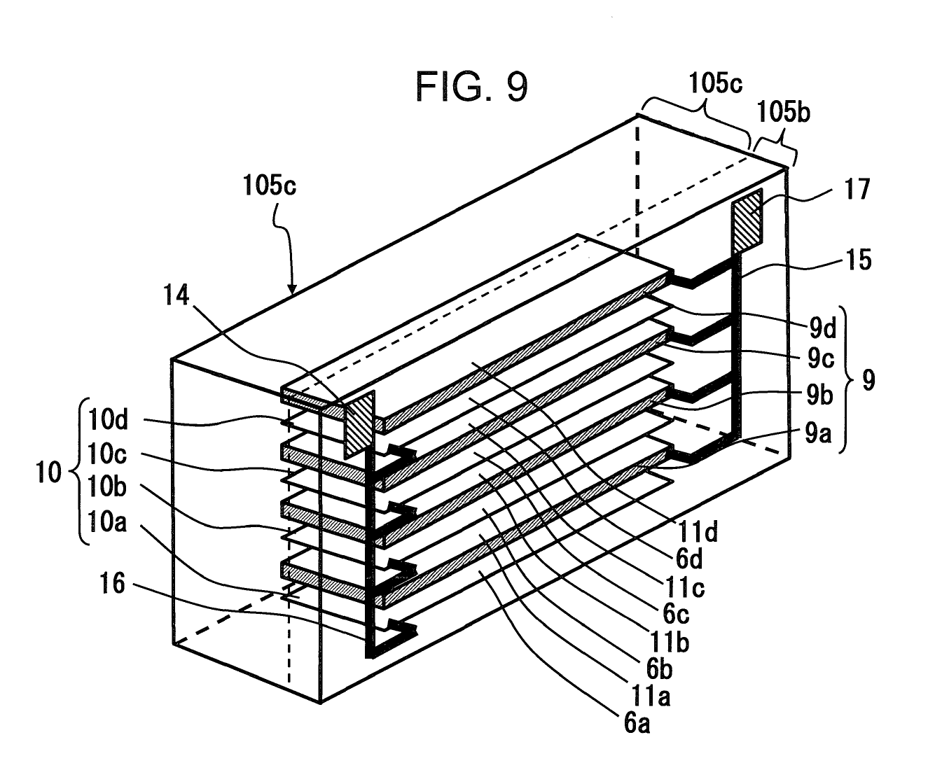

FIG. 9 is a conceptual perspective view only illustrating the arrangement of the first electrode, the second electrode, electrode leads, and electrode pads, the electrode leads and the electrode pads being electrically connected to the first and second electrodes, in the actuator 105c of the head slider shown in FIGS. 3 to 5.

The first electrode 9 is electrically connected to an electrode lead 15 and an electrode pad 17. The electrode pad 17 is located at the head slider 105 adjacent to the suspension 106. A potential is applied to the electrode pad 17 through a lead arranged on the suspension. The potential from the controller 110 is applied to the electrode lead 15 and the electrode pad 17 through the electrode pad 17. The electrode lead 15 is defined as a wiring pattern that connects the electrode pad 17 and the first electrode 9 through the via. The first electrode 9 is defined as a sheet wiring pattern connected to a plurality of portions of the electrode lead 15.

The second electrode 10 is electrically connected to an electrode lead 16 and an electrode pad 14. The electrode pad 14 is located at the head slider 105 adjacent to the suspension 106. A potential from the controller 110 is applied to the electrode pad 14 through a lead (not shown). The electrode lead 16 is defined as a wiring pattern that connects the electrode pad 14 and the second electrode 10 through the via. The second electrode 10 is defined as a sheet wiring pattern connected to a plurality of portions of the electrode lead 16.

One of the first electrode 9 and the second electrode 10 serves to apply a negative potential to the piezoelectric component 6. The other serves to apply a positive potential to the piezoelectric component 6. Usually, a negative potential is applied to the first electrode, and a positive potential is applied to the second electrode. In this case, for example, the negative potential is a ground potential of the magnetic disk drive 101.

The head slider according to this embodiment will be described again with reference to FIG. 5. The resin component 11 is arranged between adjacent operating units 18 (for example, the resin component 11b is arranged between the operating unit 18a and the operating unit 18b). The resin component 11 may have electrical insulation. The resin component 11 may be composed of a material except piezoelectric materials. The resin component 11 may be more easily deformable (softer) than the first electrode 9, the second electrode 10, and the piezoelectric component 6. Examples of a material that can be used for the resin component 11 include urethane, polyimide, epoxy, and aramid resins. From the viewpoint of high thermostability, polyimide resins are preferably used. Alternatively, an insulating material having a Young's modulus lower than that of the piezoelectric component may be used even if the insulating material is not a resin. For example, a ceramic material such as foam glass containing many minute bubbles may also be used. An insulating layer 6′ is arranged between the actuator 105c and the slider substrate 105a. The insulating layer 6′ serves to inhibit an electrical short-circuit between the slider substrate 105a composed of a conductive material such as AlTiC and the first and second electrodes 9 and 10. A material that can be used for the insulating layer 6′ is not particularly limited as long as the material has insulation. Examples of the material include alumina (Al₂O₃) and titanium oxide (TiO₂) in addition to the piezoelectric materials usable for the piezoelectric component 6. Preferably, the insulating layer 6′ composed of the piezoelectric material used for the piezoelectric component 6 is formed integral with the piezoelectric component 6 because the insulating layer is formed without an increase in the number of production steps as described in a method for manufacturing a head slider below.

The magnetic head 105b is arranged in order to write information on the storage medium or read information from the storage medium in the storage device. The magnetic head 105b includes the element 105d and the insulating layer 8. The magnetic head 105b has a thickness of, for example, about 30 μm.

The element 105d is arranged in order to write information on the storage medium or read information from the storage medium in the storage device. Examples of an element used for the magnetic disk drive include a recording element segment that serves to write information on the storage medium and a reproducing element segment that serves to read information stored in the recording medium as electric signals. The recording element segment includes, for example, a write coil, a main magnetic pole layer, and an auxiliary magnetic pole layer. The write coil serves to generate magnetic flux. The main magnetic pole layer serves to collect the magnetic flux generated by the write coil and release the magnetic flux toward the magnetic disk. The auxiliary magnetic pole layer serves to circulate the magnetic flux released from the main magnetic pole layer through the magnetic disk. An example of the reproducing element segment is a magnetoresistive element (MR element) segment. The element 105d may include at least one of the recording element segment and the reproducing element segment. Alternatively, the element 105d may include both segments.

The insulating layer 8 is arranged in order to electrically and magnetically insulate the actuator 105c from the magnetic head 105b and insulate the plurality of elements from each other. The insulating layer 8 is composed of an insulating material and has a thickness of, for example, about 1 to 50 μm. Examples of a material that can be used for the insulating layer 8 include nonmagnetic nonconductive materials, such as metal oxides, e.g. alumina (Al₂O₃), silicon oxide (SiO₂), and titanium oxide (TiO₂).

The layer structure of the magnetic head 105b is not particularly limited. A magnetic head for use in a magnetic storage device may be used in accordance with the application. Details of the layer structure of the floating head and a method for manufacturing the head are omitted in this specification.

The insulating layer 7 is arranged between the actuator 105c and the magnetic head 105b in order to electrically and magnetically insulate the actuator 105c from the magnetic head 105b. The insulating layer 7 is composed of an insulating material and has a thickness of, for example, about 0.1 to 50 μm. Examples of a material that can be used for the insulating layer 7 include nonmagnetic nonconductive materials, such as alumina (Al₂O₃), silicon oxide (SiO₂), and titanium oxide (TiO₂).

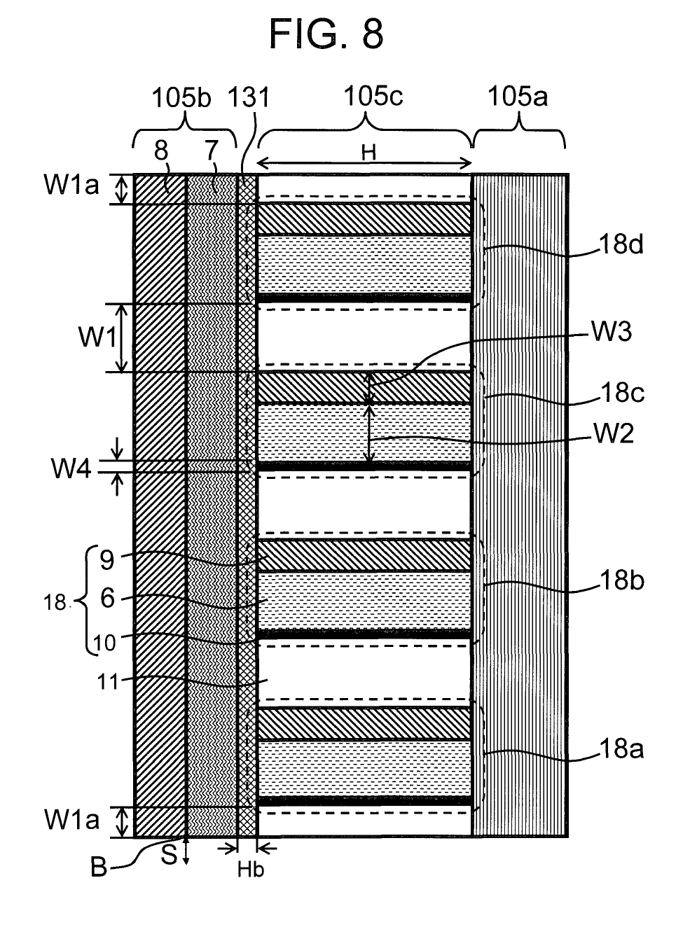

FIG. 8 is a schematic view of a head slider including the magnetic head 105b, a resin layer 131, the actuator 105c, and the AlTiC substrate 105a. As shown in FIG. 8, the resin layer 131 may be arranged between the actuator 105c and the insulating layer 7. The resin layer 131 may have electrical insulation. The resin layer 131 may be composed of a material having a Young's modulus lower than that of the piezoelectric component 6, the material being more easily deformable (softer) than the piezoelectric component 6. Examples of a material that can be used for the resin layer 131 include urethane, polyimide, epoxy, and aramid resins. From the viewpoint of high thermostability, polyimide resins are preferably used. Alternatively, a layer composed of an insulating material having a Young's modulus lower than that of the piezoelectric component, for example, a ceramic material such as foam glass containing many minute bubbles may be arranged in place of the resin layer 131.

A portion of the actuator 105c in contact with the resin layer 131 includes components, such as the piezoelectric component 6, the first electrode 9, the second electrode 10, and the resin component 11, having different degrees of resistance to deformation. When the operating unit 18 is deformed by applying a voltage to the piezoelectric component 6, the portion of the actuator 105c in contact with the resin layer 131, the portion having been flat before the application of the voltage, becomes uneven. The resin layer 131 is composed of a material having high flexibility and thus easily follows the deformation of adjacent actuator 105c. This results in an increase in the displacement of the actuator 105c in the spacing direction per unit applied voltage.

In contrast, in the head slider in which the resin layer 131 is not arranged between the actuator 105c and the magnetic head 105b as shown in FIG. 7, the deformation of the portion of the actuator 105c in contact with the magnetic head 105b is restricted compared with the head slider having the same structure except for the resin layer 131.

In a head slider having the structure as shown in FIG. 8, the displacement of point B in the spacing direction (direction of arrow S) when a voltage of 30 V was applied across the electrodes to generate an electric field was determined by simulation. Like the head slider shown in FIG. 7, the actuator 105c was set to include four operating units longitudinally arranged with a resin component provided between adjacent operating units, each of the operating units having a piezoelectric component, composed of PZT, with a width (W2 shown in FIG. 8) of 15 μm, the first electrode, composed of Ni, with a width (W3 shown in FIG. 8) of 5 μm, and the second electrode with a width (W4 shown in FIG. 8) of 0.1 μm, each operating unit having a thickness (H shown in FIG. 8) of 20 μm, and each of the resin components having a width (W1 shown in FIG. 8) of 5 μm. The thickness W1a of each of the resin component located below the operating unit 18a and the resin component located on the top of the operating unit 18d was set at 5 μm. The simulation of motion of four sliders with the resin layers 131 having thicknesses Hb of 0.1, 1, 10, and 100 μm was performed. Table 1 shows the relationship between the thickness of the resin layer 131 and the displacement of point B of the magnetic head in the spacing direction (direction of arrow S) obtained by the simulation.

TABLE 1

| THICKNESS OF | AMOUNT OF |
|---|---|
| RESIN LAYER(μm) | DISPLACEMENT(nm) |
| 0 | 14.9 |
| 0.1 | 19.5 |
| 1 | 24.2 |
| 10 | 25.6 |
| 100 | 26.3 |

The sliders each having the resin layer with a low Young's modulus, the resin layer being arranged between the actuator and the magnetic head, exhibited displacements larger than that of the slider without the resin layer 131.

Accordingly, for the sliders each having the resin layer with a low Young's modulus, the resin layer being arranged between the actuator and the magnetic head, only a low applied voltage may be required to control the displacement to a target displacement and thus power consumption may be low, as compared with the slider without the resin layer having a low Young's modulus.

The head slider according to this embodiment will be described again with reference to FIG. 3. The vias 14s and 17s and the external terminals 14t and 17t can be composed of a conductive material. Examples of the conductive material include metals, such as platinum (Pt), iridium (Ir), nickel (Ni), chromium (Cr), and copper (Cu); nitrides such as titanium nitride (TiN); carbides such as tungsten carbide (WC); and indium-tin oxide (ITO). Such a head slider is provided with the external terminals for applying an voltage to the electrodes of the operating unit, the external terminals being arranged on the surface of the head slider; hence, after the head slider is mounted on the suspension, electric connection is easily performed. Thus, the head slider according to this embodiment contributes to improvement in the production efficiency and yield of a storage device including the head slider according to this embodiment.

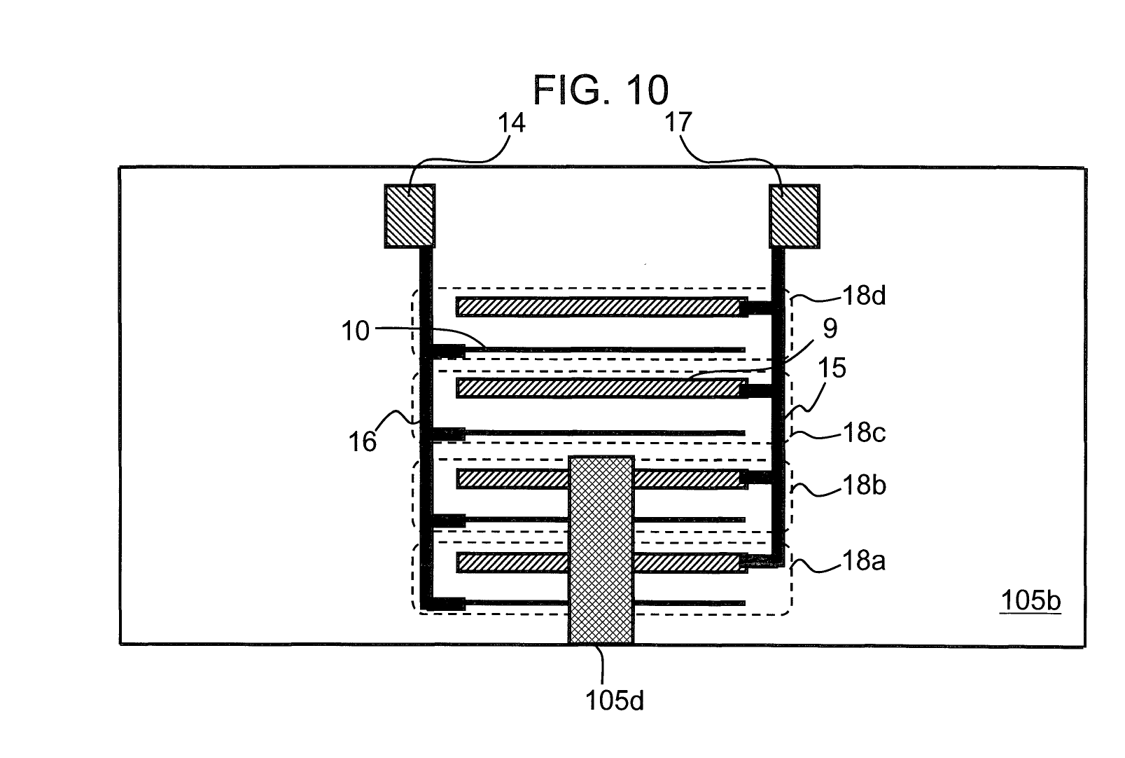

FIG. 10 is a schematic view illustrating the positional relation of the element 105d and the operating unit 18 when viewed from the leading edge of the head slider. The head slider according to this embodiment includes the operating unit 18 arranged between the substrate 105a (not shown) and the element 105d. The head slider having the positional relation of the operating unit 18, the substrate 105a, and the element 105d has a large displacement of the element 105d relative to the displacement of the operating unit 18 and thus has high operating efficiency, which is preferred from the viewpoint of contributing to an increase in the control speed of the flying height. In the head slider of the present invention, the operating unit 18 is not necessarily arranged between the substrate 105a and the element 105d.

The head slider according to this embodiment includes the small unimorph piezoelectric element arranged between the substrate and the magnetic head. Since the piezoelectric element is small, the resonance frequency of the magnetic head in the spacing direction can be increased. Since the resonance frequency is high, in the case where the head slider is arranged at a position facing the storage medium in the storage device, a high operating frequency of the piezoelectric element can be set. A high operating frequency of the piezoelectric element results in precise and rapid correction of the flying height in response to a change in the distance between the floating surface (reference numeral 105f shown in FIG. 4) of the slider and the storage medium (reference numeral 104 shown in FIG. 4) due to a change in atmospheric pressure and thermal expansion during the operation of the storage device and in response to a change in acceleration due to impact and vibration of the storage device. In the storage device including the head slider according to this embodiment, it is possible to prevent the head from coming into contact with the storage medium and damaging the storage medium (i.e., head crash) due to a strong impact on the storage device when the storage device drops. Furthermore, the flying height can be stabilized by precise and rapid correction of the flying height in response to a change in flying height during one revolution of the disk due to, for example, undulations and irregularities of the magnetic disk and the side-to-side runout of the spindle.

Moreover, the head slider according to this embodiment advantageously has no difference in degree of projection between a read section and a write section because the entire magnetic head attached to the unimorph piezoelectric element is translated, unlike a thermal actuator.

### Method for Manufacturing Head Slider

In a method for manufacturing a head slider according to the present invention, layers constituting a piezoelectric actuator provided with a piezoelectric element including a piezoelectric component, a first electrode, and a second electrode on a substrate wafer are directly formed by a thin-film-forming process including deposition and microfabrication. Thus, the actuator and a magnetic head can be successively formed.

Examples of the film-forming process include plating, such as electroplating and electroless plating; physical vapor deposition (PVD), such as sputtering and evaporation; chemical vapor deposition (CVD) such as metal-organic chemical vapor deposition (MO-CVD); application, such as spin coating, dipping, and spraying; and thick-film printing. These are appropriately selected according to the purpose. Examples of microfabrication include milling such as ion milling; processing with a dicing saw; and polishing such as chemical-mechanical polishing (CMP).

With respect to a method for forming the actuator, a method for directly forming the actuator on the substrate wafer is preferred from the viewpoint of achieving a high yield and a low cost compared with a known process including bonding an actuator to a slider with an adhesive and bonding a magnetic head to the slider. The resulting head slider has the same advantages as those of the foregoing head slider according to the embodiment of the present invention.

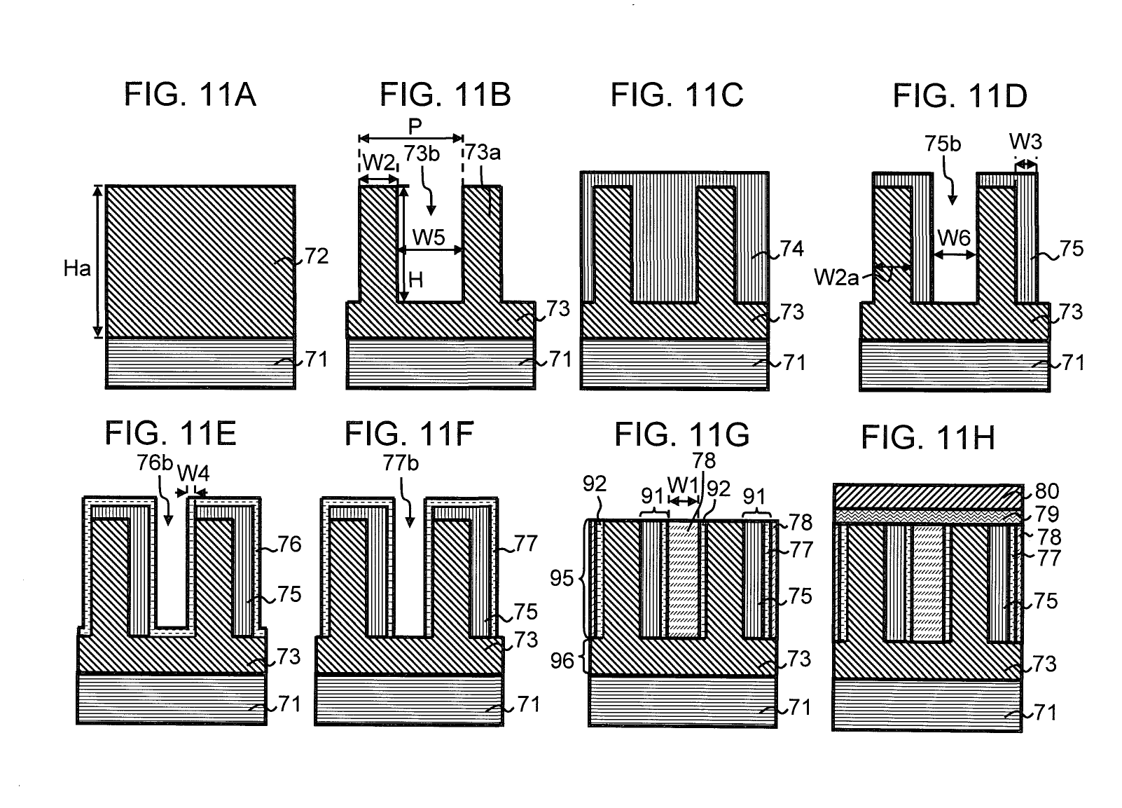

Embodiments of the method for manufacturing the head slider according to the present invention will be described below. FIGS. 11A to 11H are schematic cross-sectional views illustrating steps in the method for manufacturing the head slider according to an embodiment of the present invention. Each of the steps will be described below.

### (1) Step of Forming Piezoelectric Component

As shown in FIG. 11A, a piezoelectric component 72 is formed on a slider substrate 71. Materials that can be used for the slider substrate 71 and the piezoelectric component 72 may be the same as those described in “Head Slider” above.

As the slider substrate, for example, an AlTiC (Al₂O₃—TiC) substrate in the form of a wafer is used. The AlTiC substrate 71 constitutes the slider substrate 105a of the head slider 105 shown in FIG. 5 after all production steps are completed.

The piezoelectric component 72 constitutes the piezoelectric component 6 constituting the head slider 105 shown in FIG. 5 after all production steps are completed. Furthermore, the piezoelectric component 72 may constitute the insulating layer 6′ of the head slider 105 shown in FIG. 5 after all production steps are completed.

Usable examples of a method for forming the piezoelectric component 72 include, but are not particularly limited to, sputtering, a sol-gel process, pulsed laser evaporation, MOCVD, thick-film printing, green-sheet lamination, and aerosol deposition. Examples of a piezoelectric material that can be used for the piezoelectric component 72 include perovskite oxides, such as lead zirconate titanate (Pb(Zr,Ti)O₃ (PZT)), Nb-containing PZT, PNN-PZT {Pb(Ni,Nb)O₃—PbTiO₃—PbZrO₃}, and PMN-PZT {Pb(Mg,Nb)O₃—PbTiO₃—PbZrO₃}. Furthermore, potassium niobate (KNbO₃), aluminum nitride (AlN), and the like may be used. The piezoelectric component 72 has a thickness Ha of, for example, about 25 μm.

### (2) Step of Processing Piezoelectric Component

The resulting piezoelectric component 72 is subjected to processing to form a piezoelectric component 73 having projections as shown in FIG. 11B. Non-limiting examples of processing that can be employed include processing with a dicing saw, milling, and reactive ion etching. Projections 73a each have a width W2 of, for example, about 10 μm and a depth H of, for example, about 20 μm. The pitch P of the projections is about 15 μm.

### (3) Step of Forming First Electrode

A first conductive layer 74 for forming the first electrode is formed on the piezoelectric component 73 having the projections as shown in FIG. 11C. In this embodiment, the first electrode has a high resistance to crashing compared with the second electrode. That is, the product of the Young's modulus and the thickness of the first electrode is larger than the product of the Young's modulus and the thickness of the second electrode.

The first conductive layer 74 is composed of a conductive material constituting the first electrode 9 of the head slider 105 shown in FIG. 5 after all production steps are completed. Examples of a material that can be used for the first conductive layer 74 include metals such as nickel (Ni), platinum (Pt), iridium (Ir), chromium (Cr), and copper (Cu). Examples of a material that can be used for the first conductive layer 74 further include nitrides such as titanium nitride (TiN); carbides such as tungsten carbide (WC); and indium-tin oxide (ITO). Non-limiting examples of a method for forming the first conductive layer 74 include plating, such as electroplating and electroless plating; physical vapor deposition (PVD), such as sputtering; and chemical vapor deposition (CVD) such as metal-organic chemical vapor deposition (MO-CVD). Among these, the first conductive layer 74 is preferably formed by electroless nickel plating in view of cost.

The first conductive layer 74 is subjected to processing to form a groove 75b in such a manner that first conductive layers 75 each have a target thickness as shown in FIG. 1D. In this case, the processing is performed in such a manner that the first conductive layer is left on only one side of each projection 73a. Non-limiting examples of the processing include processing with a dicing saw and milling. The first conductive layers 75 each have a thickness of, for example, about 5 μm.

The first electrode is formed through a step of forming the second electrode, a step of forming a resin component, and a polishing step. In this step, each first conductive layer 75 serves as a main layer constituting a first electrode 91. Furthermore, the projections 73a may be processed simultaneously with the processing of the first conductive layer 74 to adjust width W2′.

### (4) Step of Forming Second Electrode

As shown in FIG. 1E, a second conductive layer 76 is formed so as to cover the first conductive layers 75 and the projections 73a. In this embodiment, the second electrode has a low resistance to crashing compared with the first electrode. That is, the product of the Young's modulus and the thickness of the second electrode is smaller than the product of the Young's modulus and the thickness of the first electrode.

The second conductive layer 76 is composed of a conductive material constituting the second electrode 10 of the head slider 105 after all production steps are completed. Examples of a material that can be used for the second conductive layer 76 include metals such as nickel (Ni), platinum (Pt), and iridium (Ir). Examples of a material that can be used for the second conductive layer 76 further include nitrides such as titanium nitride (TiN); and indium-tin oxide (ITO). Non-limiting examples of a method for forming the second conductive layer include plating, such as electroplating and electroless plating; physical vapor deposition (PVD), such as sputtering; and chemical vapor deposition (CVD) such as metal-organic chemical vapor deposition (MO-CVD). Among these, the second conductive layer 76 constituted by a thin nickel film is preferably formed by sputtering from the viewpoint of ease of the formation of the second electrode having a low resistance to crashing compared with the first electrode. The second conductive layer usually has the same thickness as the second electrode, e.g., about 0.1 μm.

The second conductive layer 76 located on the bottom of a groove 76b shown in FIG. 11E is subjected to processing to form second conductive layers 77 as shown in FIG. 11F. Non-limiting examples of the processing include processing with a dicing saw and milling such as ion milling.

### (5) Formation of Resin Component and Polishing Step

A groove 77b shown in FIG. 11F is filled with a resin component 78. The resin component 78 may have electrical insulation. The resin component 78 may be composed of a material except piezoelectric materials. The resin component 11 may be more easily deformable (softer) than the first electrode 75, the second electrode 77, and the piezoelectric component 73. Non-limiting examples of a method for filling the groove with the resin component include spin coating, dipping, and spraying. The resin component 78 has a thickness W1a of, for example, about 5 μm.

Tops of the projections 73a having the first conductive layers 75 and the second conductive layers 77 are polished until the projections 73a are exposed, thereby forming thick electrodes 91 each constituted by the first conductive layer 75 and the second conductive layer 77 and thin electrodes 92 each constituted by the second conductive layer 77 as shown in FIG. 11G. In this way, a laminate including an actuator 95 on the slider substrate 71 is obtained. An example of a polishing method is, but not limited to, chemical-mechanical polishing (CMP).

### (6) Step of Forming Magnetic Head

As shown in FIG. 11H, an insulating film 79 composed of, for example, alumina is formed on the laminate. Then a magnetic head 80 is formed by a common head-forming process. The layer structure of the magnetic head 80 is not particularly limited. A magnetic head for use in a magnetic storage device may be used in accordance with the application. Details of the layer structure of the magnetic head and a method for manufacturing the head are omitted in this specification.

A layer (not shown) having a Young's modulus lower than that of the piezoelectric component 73 may be formed on the laminate before the formation of the insulating film 79. This layer may have electrical insulation, a Young's modulus lower than that of the piezoelectric component 73, and may be more easily deformable (softer) than the piezoelectric component 73, as described in the illustration of the resin layer 131 of the head slider. The low-Young's-modulus layer can be formed by a means appropriately selected from spin coating, dipping, vapor-phase polymerization, and the like in response to the material.

A known processing for forming a floating surface of the slider is performed, thereby completing the head slider according to this embodiment.

The method of the embodiment does not include a step of positioning or bonding minute components; hence, the head slider can be easily produced in high yield compared with common semiconductor production processes.

### Storage Device

A storage device of the present invention includes a head slider having a small unimorph piezoelectric element arranged between a substrate and a magnetic head. The storage device of the present invention has the same advantages as those of the foregoing head slider according to the embodiment of the present invention.

A storage device configured to write and read information, the storage device including a storage medium and a head slider arranged so as to face the storage medium, in which the head slider includes: a slider substrate; an operating unit arranged on the slider substrate, the operating unit having a pair of electrodes and a piezoelectric component arranged between the pair of electrodes, the pair of electrodes being constituted by a first electrode and a second electrode, in which the product of the Young's modulus and the thickness of the first electrode in the direction from the first electrode to the second electrode is larger than the product of the Young's modulus and the thickness of the second electrode in the direction from the first electrode to the second electrode; and a magnetic head arranged on the slider substrate with the operating unit, opposite to the slider substrate.

A magnetic recording device as a storage device according to an embodiment of the present invention has been briefly described with reference to FIGS. 1, 2, and 4; hence, details are omitted. A method for manufacturing the storage device may refer to known techniques.

The present invention is not limited to the foregoing embodiments. These embodiments are merely exemplary in nature. It is to be understood that changes and variations may be made without departing from the spirit or scope of the claims.

### EXAMPLES

### Example 1

A method for manufacturing a head slider according to Example 1 will be described below with reference to FIGS. 11A to 11H.

As shown in FIG. 11A, a PZT film (Young's modulus: 65 GPa), as the piezoelectric component 72, having a thickness Ha of 25 μm was formed on the AlTiC slider substrate 71 by CVD. The resulting piezoelectric component 72 was processed with a dicing saw to form the uneven pattern 73 with the projections 73a each having a width W2 of 10 μm and a height H of 20 μm and with the groove 73b having a width W5 of 20 μm and a depth H of 20 μm, the pitch P of the pattern being 30 μm as shown in FIG. 11B. The processed piezoelectric component 73 was subjected to electroless Ni plating to fill the groove 73b with a Ni plating film (Young's modulus: 220 GPa) as the first conductive layer 74 as shown in FIG. 11C. The first conductive layer 74 was subjected to grooving with a dicing saw in such a manner that the width W6 was 15 Mm, thereby forming the first conductive layers 75 having a width W3 of 5 μm as shown in FIG. 1D. As shown in FIG. 1E, a thin Ni film (Young's modulus: 50 GPa), as the second conductive layer 76, having a thickness W4 of 0.1 μm was formed by DC sputtering so as to cover the first conductive layers 75 and the piezoelectric layer 73. Removal of the bottom of the second conductive layer 76 in the groove by ion milling resulted in the formation of the second conductive layers 77 as shown in FIG. 11F. The groove 77b was filled with a polyimide resin 78 (Young's modulus: 0.5 GPa) as shown in FIG. 11G. The surface was polished by CMP. This polishing resulted in the thick electrodes (first electrode) 91 each constituted by the first conductive layer 75 and the second conductive layer and the thin electrodes (second electrodes) 92 each constituted by the second conductive layer 77, the projections 73a of the piezoelectric component being arranged between the thick electrodes 91 and the thin electrodes 92. As shown in FIG. 11H, after an alumina film was formed by RF magnetron sputtering, the magnetic head element was formed by a common head-forming process. Furthermore, a common processing for forming a floating surface of the slider was performed at a predetermined portion of the AlTiC substrate. For the resulting head slider, the resonance frequency of the magnetic head in the spacing direction was measured by a laser Doppler method and found to be about 5 MHz.

The resulting head slider and a known head slider having a flying-height-controlling mechanism with a thermal actuator were each examined to evaluate power consumption per unit displacement and the maximum frequency (operation limit frequency) of an AC electric field applied to the first electrode and the second electrode within a range in which the flying height can be controlled using a flying evaluation device. In the case where the same displacement was obtained at an operating frequency of 1 kHz, the head slider according to Example 1 was operable with a power consumption equal to or less than 1/1,000 of that of the head with the thermal actuator. The operation limit frequency of the head slider according to Example 1 was 100 or more times higher than the operation limit frequency of the head with the thermal actuator.

### Example 2

A method for manufacturing a head slider according to Example 2 will be described below with reference to FIGS. 11A to 11H.

As shown in FIG. 11A, a paste containing a PNN-PZT piezoelectric ceramic powder was applied as the piezoelectric component 72 on the slider substrate 71 composed of AlTiC by printing, fired at 1,100° C., and subjected to hot isostatic pressing (HIP), thereby forming a dense PNN-PZT piezoelectric ceramic layer (Young's modulus: 55 GPa) without pores. The thickness of the piezoelectric component 72 was set at 25 μm. The subsequent steps were performed as in Example 1, thereby a head slider according to Example 2. The resonance frequency of the resulting head slider in the spacing direction was about 5 MHz.

The resulting head slider and a known head slider having a flying-height-controlling mechanism with a thermal actuator were each examined to evaluate power consumption per unit displacement and the operation limit frequency using a flying evaluation device. In the case where the same displacement was obtained at an operating frequency of 1 kHz, the head slider according to Example 2 was operable with a power consumption equal to or less than 1/1,000 of that of the head with the thermal actuator. The operation limit frequency of the head slider according to Example 2 was 100 or more times higher than the operation limit frequency of the head with the thermal actuator.

### Example 3

A method for manufacturing a head slider according to Example 3 will be described below with reference to FIGS. 11A to 11H.

As shown in FIG. 11A, a PZT film (Young's modulus: 65 GPa), as the piezoelectric component 72, having a thickness of 10 μm was formed on the AlTiC slider substrate 71 by RF magnetron sputtering. The resulting piezoelectric component 72 was processed with a dicing saw to form the piezoelectric component 73 having an uneven pattern with the projections 73a each having a width W2 of 10 μm and a height H of 10 μm and with the groove 73b having a width W5 of 10 μm and a depth H of 10 μm, the pitch P of the pattern being 20 Mm as shown in FIG. 11B. The piezoelectric component 73 was subjected to electroless Ni plating to fill the groove 73b with Ni (Young's modulus: 220 GPa) as shown in FIG. 11C. Grooving was performed with a dicing saw in such a manner that the first conductive layer 74 has a width of 5 μm and that the projections 73a each have a width of 5 μm, thereby forming a Ni plating layer having a thickness W3 of 5 μm as the first conductive layers 75 and a PZT film having a thickness W2 of 5 μm as the piezoelectric component 73 as shown in FIG. 1D. The subsequent steps were performed as in Example 1, thereby a head slider according to Example 3. The resonance frequency of the resulting head slider in the spacing direction was about 5 MHz.

The resulting head slider and a known head slider having a flying-height-controlling mechanism with a thermal actuator were each examined to evaluate power consumption per unit displacement and the operation limit frequency using a flying evaluation device. In the case where the same displacement was obtained at an operating frequency of 1 kHz, the head slider according to Example 3 was operable with a power consumption equal to or less than 1/1,000 of that of the head with the thermal actuator. The operation limit frequency of the head slider according to Example 3 was 100 or more times higher than the operation limit frequency of the head with the thermal actuator.

### Example 4

A laminate as shown in FIG. 11G was produced as in Example 1. A polyimide film having a thickness of about 2 μm was applied by spin coating and cured by heat (not shown). As shown in FIG. 11H, after an alumina film was formed by RF magnetron sputtering on the polyimide film, the magnetic head element was formed by a common head-forming process. The subsequent steps were performed as in Example 1, thereby a head slider according to Example 4. The resonance frequency of the resulting head slider in the spacing direction was about 5 MHz. The voltage applied to the head slider according to Example 4 when the head slider according to Example 4 exhibited the same displacement as the head slider according to Example 1 was about 60% of the applied voltage required for the head slider according to Example 1.

The resulting head slider and a known head slider having a flying-height-controlling mechanism with a thermal actuator were each examined to evaluate power consumption per unit displacement and the operation limit frequency using a flying evaluation device. In the case where the same displacement was obtained at an operating frequency of kHz, the power consumption of the head slider according to Example 4 was equal to or less than 1/1,000 of that of the head with the thermal actuator and was equal to or less than half the power consumption of the head slider according to Example 1. The operation limit frequency of the head slider according to Example 4 was 100 or more times higher than the operation limit frequency of the head with the thermal actuator.

What is claimed is:

1. A head slider comprising:
a slider substrate;
an operating unit arranged on the slider substrate, the operating unit having a pair of electrodes and a piezoelectric component arranged between the pair of electrodes, the pair of electrodes being constituted by a first electrode and a second electrode, in which the product of the Young's modulus and the thickness of the first electrode in the direction from the first electrode to the second electrode is larger than the product of the Young's modulus and the thickness of the second electrode in the direction from the first electrode to the second electrode; and
a magnetic head arranged on the slider substrate with the operating unit, opposite to the slider substrate.

2. The head slider according to claim 1, wherein each of the electrodes extends longitudinally in the direction from the slider substrate to the magnetic head.

3. The head slider according to claim 1, wherein the thickness of the first electrode in the direction from the first electrode to the second electrode is larger than the thickness of the second electrode in the direction from the first electrode to the second electrode.

4. The head slider according to claim 1, wherein an application of an electric field across the pair of electrodes results in the deformation of the piezoelectric component in the direction perpendicular to the direction of the electric field, so that the magnetic head is displaced in the direction of the electric field.

5. The head slider according to claim 1, further comprising an insulating layer arranged between the pair of electrodes and the slider substrate.

6. The head slider according to claim 1, further comprising:
an electrically insulating layer arranged between the magnetic head and the operating unit, the insulating layer having a first via and a second via, the first and second vias having conductivity, wherein the operating unit has a first terminal and a second terminal, the first terminal being electrically connected to the first electrode, the second terminal being electrically connected to the second electrode, and the magnetic head has a third terminal and a fourth terminal on a surface of the magnetic head, the third terminal being electrically connected to the first terminal through the first via, the fourth terminal being electrically connected to the second terminal through the second via.

7. The head slider according to claim 1, further comprising:
another operating unit arranged on the slider substrate, the operating unit having a pair of electrodes and a piezoelectric component arranged between the pair of electrodes, the pair of electrodes being constituted by a first electrode and a second electrode, in which the product of the Young's modulus and the thickness of the first electrode in the direction from the first electrode to the second electrode is larger than the product of the Young's modulus and the thickness of the second electrode in the direction from the first electrode to the second electrode, wherein the magnetic head is arranged on the slider substrate with the operating units, opposite to the slider substrate.

8. The head slider according to claim 1, further comprising:
a layer arranged between the operating unit and the magnetic head, the layer having a Young's modulus lower than that of the piezoelectric component.

9. The head slider according to claim 7, further comprising:
a component arranged between the adjacent operating units, the component having a Young's modulus lower than those of the piezoelectric components.

10. The head slider according to claim 1, wherein the pair of electrodes contain nickel.

11. The head slider according to claim 1, wherein the magnetic head includes a write unit for writing information, and the operating unit is arranged between the slider substrate and the write unit.

12. The head slider according to claim 1, wherein the magnetic head includes a read unit for reading information, and the operating unit is arranged between the slider substrate and the read section.

13. A head slider comprising:
a slider substrate;
an operating unit arranged on the slider substrate, the operating unit having a pair of electrodes and a piezoelectric component arranged between the pair of electrodes, and the pair of electrodes being constituted by a first electrode and a second electrode; and
a magnetic head arranged on the slider substrate with the operating unit provided therebetween, each of the first electrode and the second electrode having a thickness in the direction from the first electrode to the second electrode such that the magnetic head is displaced in the direction of the electric field when an electric field applied across the pair of electrodes causes deformation of the piezoelectric component in the direction perpendicular to the direction of the electric field.

14. The head slider according to claim 13, further comprising:
a layer arranged between the operating unit and the magnetic head, the layer having a Young's modulus lower than that of the piezoelectric component.

15. A method for manufacturing a head slider, comprising:
providing a slider substrate;
forming a piezoelectric component on the slider substrate;
processing the piezoelectric component in such a manner that the piezoelectric component has a projection;
forming a first electrode on one side of the projection, the product of the Young's modulus of the first electrode and the thickness of the first electrode in the direction in which the first electrode and the second electrode are connected to each other being a first value;
forming a second electrode on the other side of the projection, the product of the Young's modulus of the second electrode and the thickness of the second electrode in the direction in which the first electrode and the second electrode are connected to each other being a second value smaller than the first value; and
forming a magnetic head above the slider substrate having the projection, the first electrode, and the second electrode.

16. The method for manufacturing a head slider according to claim 15, wherein each of the electrodes extends longitudinally in the direction from the slider substrate to the magnetic head.

17. The method for manufacturing a head slider according to claim 15, further comprising:
forming a layer having a Young's modulus lower than that of the piezoelectric component before forming the magnetic head above the slider substrate having the projection, the first electrode, and the second electrode.
